(19) United States
(12) Patent Application Publication
(10) Pub. No.: US 2002/0033551 A1
(43) Pub. Date: Mar. 21, 2002

(54) Method and injection-moulding tool for moulding a plastic part, in particular a mudguard and panelling parts for motor vehicles

(76) Inventor: Gerhard Sorgel, Deutschland (DE)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/951,445

(22) Filed: Sep. 14, 2001

(30) Foreign Application Priority Data
Sep. 16, 2000 (DE) 100 45 966.8
Dec. 2, 2000 (DE) 100 59 958.3

(51) Int. Cl. B29C 45/14; B29C 45/40

(52) U.S. Cl. 264/161; 264/259; 425/556; 425/577

(57) ABSTRACT

The invention relates to a method of moulding a plastics part (7), in particular a mudguard and panelling parts for motor vehicles, in an injection-moulding method by edge injection moulding via an edge sprue or film sprue (8), wherein the finished plastics part has a visible outside surface (11) and an invisible inside surface, using a tool comprising a core plate (9) and a cavity plate (10), wherein there is formed between the latter a cavity that matches the shape of the plastics part (7).

So that finishing in regard to the sprue is unnecessary, it is proposed that the sprue surface is placed on the unseen inside surface and that the sprue (8) is cut off or channelled out over its entire length by a blade (3) actuated by a slider (1, 2) when the tool is opened.

In addition, an associated injection-moulding tool is also specified.

The invention relates to a method of moulding a plastic part, in particular a mudguard and panelling parts for motor vehicles, in an injection-moulding method by edge injection moulding via an edge sprue or film sprue, wherein the finished plastic part has a visible outside surface and an unseen inside surface, using a tool comprising a core plate and a cavity plate, with there being formed between the latter a cavity that matches the shape of the plastics part. Furthermore, the invention relates to an injection-moulding tool for carrying out the method.

Plastics parts that are injection moulded from the side via an edge sprue or film sprue have to be machined subsequently with additional expenditure by means of milling, cutting or trimming to remove residues of the sprue. The outside surface is generally visibly altered by this machining. In addition, this finishing is cost-intensive.

The object of the invention is therefore to provide a method of moulding a plastics part and an associated injection-moulding tool, with which there is no necessity for finishing.

According to the invention, this object is achieved in regard to the method in that the injecting moulding surface is placed on the unseen inside surface and in that the sprue is cut off or channelled out over its entire length by a blade actuated by a slider when the tool is opened.

No finishing is necessary as a result of the automatic cutting-off or channelling out of the sprue while still in the tool. Since the injection moulding surface is positioned on the unseen inside surface of the plastics part, any visible residues of the sprue are not troublesome.

Advantageously, the sprue is separated via the machine programming by channelling out or cutting-off after the follow-up pressure of the injection-moulding operation. The sprue is completely separated when there is channelling out on opening of the tool by the core plate.

In this operation, the sprue cut off or channelled out by the blade is ejected from the mould by means of at least one sprue ejector. Expediently, a top ejector is additionally used.

An injection-moulding tool according to the invention is characterized by the features of claim 5.

According to the invention, at least one sprue ejector that ejects the sprue from the mould is disposed in the injection-moulding tool.

Further features of the invention emerge from the figures, which are described below. In the figures:

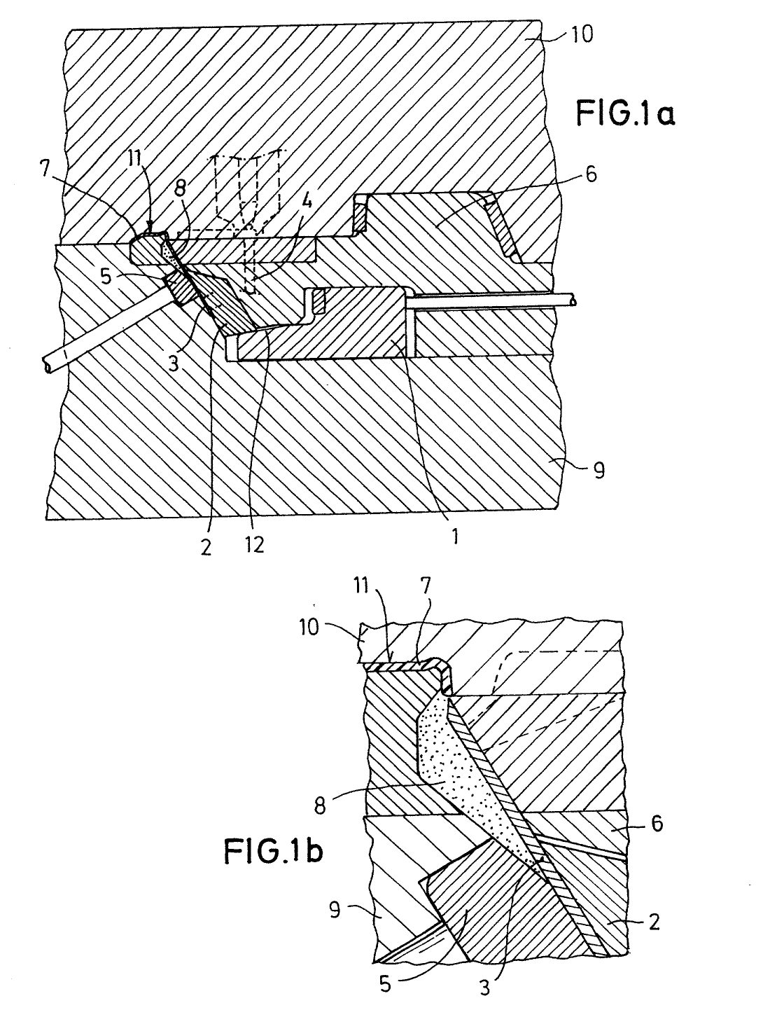

FIGS. 1a, 1b show cutaways of a closed injection-moulding tool having an injection-moulded plastics part still in the mould,

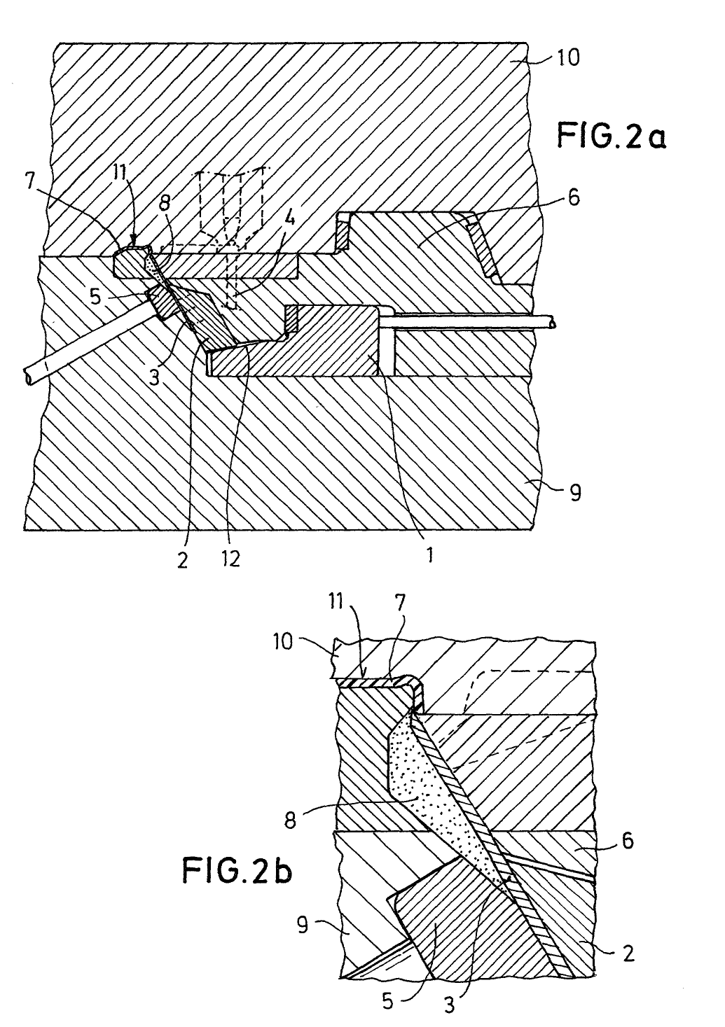

FIGS. 2a, 2b show cutaways of a closed injection-moulding tool with an extended blade that has already cut off or channelled out the sprue,

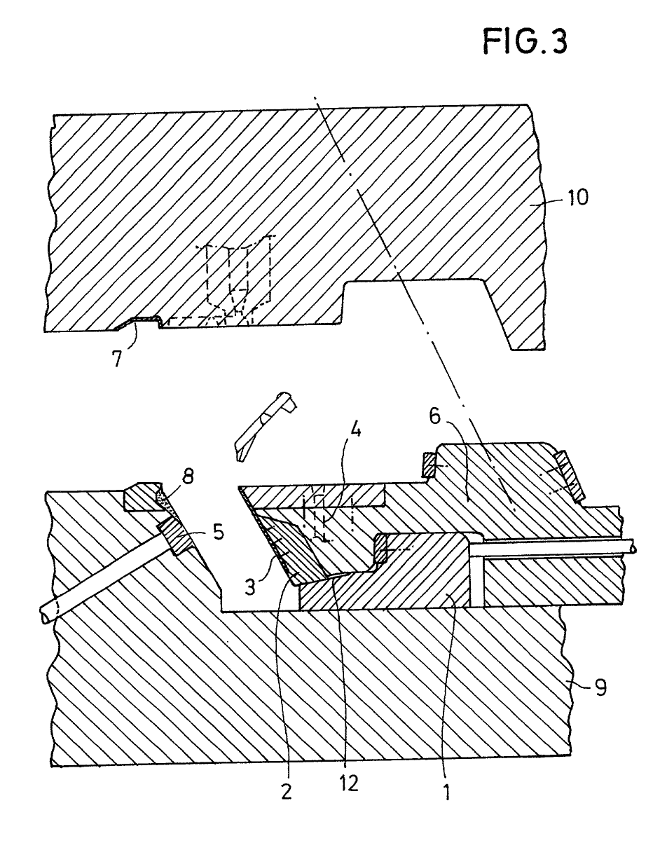

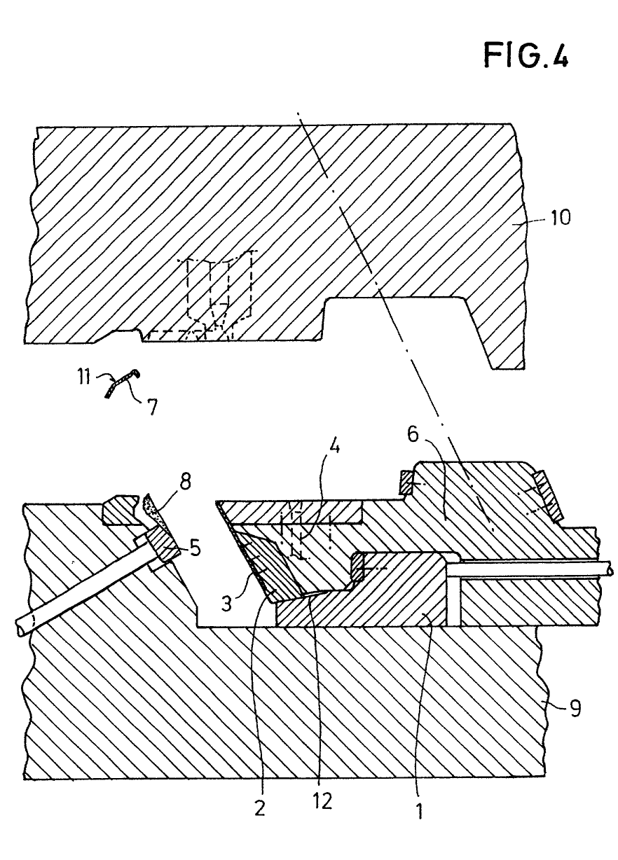

FIGS. 3, 4 show an opened injection-moulding tool with actuated sprue ejector and top ejector and a sprue demoulded thereby and a demoulded plastic part.

FIGS. 1a and 1b show an injection-moulding tool according to the invention for plastic parts, having a core plate 9 and a cavity plate 10. Disposed between the latter is an injection-moulded finished plastics part 7. The visible outside surface 11 of said plastics part 7 is disposed towards the cavity plate 10. Only the essential features according to the invention are described below. As is normal in injection-moulding tools, the other parts of said injection-moulding tool are likewise present.

The plastics part 7 was produced by edge injection moulding via an edge sprue or film sprue 8. To cut off said sprue 8, a hydraulically actuated slider 1 is disposed in the mechanically actuated main slider 6. The latter has a bevel 12 at the end thereto, on which a further slider 2 rests. Attached to said further split 2 is a blade 3 that is positioned in such a way that, in the extended state, it cuts off the sprue 8.

FIG. 1a shows the blade 3 still in the retracted state, i.e. the sprue has not yet been cut off. FIG. 1b shows an enlarged cutaway of said blade 8 resting against the sprue 8 or the plastics part 7.

The further parts of the injection-moulding tool are explained by reference to the subsequent figures.

FIGS. 2a, 2b show the same injection-moulding tool as FIGS. 1a, 1b except that in this case the blade 3 is extended, i.e. the hydraulically actuated slider 1 is extended, as a result of which the further slider 2 slides up on the bevel 12. Since the blade 3 is attached to the further slider 2, the sprue 8 is cut off or channelled out by this lifting movement.

FIG. 3 shows the injection-moulding tool just described in the opened state: The main slider 6 with the slider 1 and the further slider 2 is laterally retracted and a sprue ejector 4 is operated mechanically by means of an arm. The plastics part 7 is still located in the cavity plate 10.

FIG. 4 shows the injection-moulding tool just described in the next step in the method. Disposed in the core plate 9 is a hydraulically actuated top ejector 5. This top ejector 5 ejects the residual sprue 8 out of the mould. The plastics part 7 is demoulded from the cavity plate 10 and now does not have any sprue. The visible sprue surface is free of damage since the sprue was disposed on the unseen inside surface.

Preferably, this method or tool is used for mudguards and panelling parts for motor vehicles.

1. Method of moulding a plastics part (7), in particular a mudguard and panelling parts for motor vehicles, in an injection-moulding method by edge injection moulding via an edge sprue or film sprue (8), wherein the finished plastic part has a visible outside surface (11) and an unseen inside surface, using a tool comprising a core plate (9) and a cavity plate (10), wherein there is formed between the latter a cavity that matches the shape of the plastics part (7) characterized in that the sprue surface is positioned on the unseen inside surface and in that the sprue (8) is cut off or channelled out over its entire length by a blade (3) actuated by a slider (1, 2) when the tool is opened.

2. Method according to claim 1, characterized in that the tool is opened and the sprue is cut off or channelled out by means of the machine programming.

3. Method according to claim 1 or 2, characterized in that the sprue (8) cut off or channelled out by the blade (3) is ejected from the mould by means of at least one sprue ejector (4).

4. Method according to claim 3, characterized in that a top ejector (5) is additionally used.

5. Injection-moulding tool for moulding a plastics part (7), in particular a mudguard and panelling parts for motor vehicles, by edge injection moulding via an edge sprue or film sprue (8), wherein the plastic part (7) has, in the finished state, a visible outside surface (11) and an unseen inside surface and the tool comprises a core plate (9) and a cavity plate (10), there being disposed between the latter a cavity that matches the shape of the plastics part (7), for carrying out the method according to one of claims 1 to 4, characterized in that the sprue surface is disposed on the invisible inside surface of the plastics part (7) and there is disposed in the core plate (9) a blade that is actuated by a slider (1, 2) and cuts off or channels out the sprue (8) over its entire length when the tool is opened.

6. Injection-moulding tool according to claim 5, characterized in that there is disposed in the injection-moulding tool at least one sprue ejector (4) that ejects the sprue (8) from the mould.

7. Plastics part, in particular a mudguard and panelling parts for motor vehicles, produced by a method according to one of claims 1 to 4 and with an injection-moulding tool according to claim 5 or 6.
